(19) United States
(12) Patent Application Publication
(10) Pub. No.: US 2007/0196785 A1
(43) Pub. Date: Aug. 23, 2007

(54) Dental appliance for deflecting gingival tissue

(76) Inventor: Graham Matheson, Vancouver (CA)

Correspondence Address: NOBLITT & GILMORE, LLC., 4800 NORTH SCOTTSDALE ROAD, SUITE 6000, SCOTTSDALE, AZ, 85251, US

(21) Appl. No.: 10/572,141

(22) PCT Filed: Aug. 16, 2004
(86) PCT No.: PCT/CA04/01517

§ 371 Date: Dec. 28, 2006

(30) Foreign Application Priority Data
Sep. 16, 2003 (CA) 2,441,907

(51) Int. Cl. A61C 5/14

(52) U.S. Cl. 433/136

(57) ABSTRACT

This invention relates to a dental appliance (10) for displacing gingival tissue during a restoration procedure. The dental appliance (10) comprises a flexible polyurethane foam pad having a central opening (12) extending through the pad. The central opening (12) is configured to receive a tooth therethrough, and the foam pad has a size, shape and flexibility sufficient to deflect gingival crest surrounding the tooth. The dental appliance (10) can be made from an open celled foam that is effective to retain a medicament for release onto the gingival tissue The medicament can be combined with an excipient to form a gelatinized compound impregnated into the pad. A temporary crown can be used to push the dental appliance (10) over a prepared tooth and onto the gingival crest surrounding the tooth, such that the entire gingival crest is simultaneously displaced.

### FIELD OF THE INVENTION

This invention relates generally to a dental appliance, and in particular, to an appliance for controllably deflecting gingival tissue around a tooth or dental implant during a dental restoration procedure.

### BACKGROUND OF THE INVENTION

Traditionally, the preparation of a tooth or dental implant for a crown or bridge involves the use of cutting and grinding instruments near or below the level of the gingiva (see FIGS. 1(a) and (b) and 2(a) and (b)). It is important for a dentist to be able to control the position of the gingival crest during the removal of old fillings and/or the shaping of the enamel and dentin. Similarly, in the preparation of a titanium implant, control of the gingival crest is important. Failure to deflect the gingival crest during this phase of the treatment can result in laceration of the gingiva and poor visualization of the area being prepared.

Following the preparation, the precise shape of the prepared tooth/implant is recorded. This recording is usually done with a fluid impression cream which subsequently solidifies into a rubbery imprint. Dental stone is then poured into the imprint to create a replica of the prepared tooth/implant. The tooth/implant shape may also be recorded with optical scanning devices to render a virtual replica of the preparation. In both situations, the replica is then used to fashion a restoration. The accuracy of the replica determines the accuracy of fit of the restoration. The accuracy of the fit will determine the lifespan of the restoration. Therefore, the recording process is critically important. The ability to deflect the gingival crest and clear it of moisture is important for an effective and accurate recording, as the impression must extend below the crown margin and thus typically also below the gingivial crest. Gingival crevicular fluid and/or blood is often present in the vicinity and must be eliminated from the field for an accurate recording.

A patient is typically fitted with a temporary crown while the permanent restoration is being fabricated. Once the restoration has been fabricated by a dental laboratory technician, the restoration is cemented onto the tooth/implant. The edge of the restoration will usually be at or below the level of the gingival crest. In such case, it is necessary to deflect the gingival tissue and clear it of moisture prior to cementation of the permanent restoration. Failure to do so can result in gingival crestal tissue being trapped and/or injured during the placement of the restoration. The presence of moisture will decrease the effectiveness of the cement bond.

Conventional technique for controlling the crestal gingiva and the fluids during the preparation, recording, and cementing stages involves the insertion of fibrous threads into the small naturally occurring space between the tooth/implant and the gingival crest; this space is known as the gingival sulcus. The fibrous threads are available in different thicknesses and materials. Typically, woven or braided cotton or silk fibers are used. A metal instrument is employed by the dentist to press these threads into the gingival sulcus (see FIGS. 3(a) and (b)). The threads may be saturated in liquid form medicaments, intended to eliminate tissue moisture and/or bleeding.

The process of inserting or packing the retraction threads or cords is time consuming and potentially traumatic to the gingival tissues. While gingival tissue must be deflected for a certain minimum period of time in order for the tissue to stay deflected long enough after the threads are removed for the dental restoration procedure to be completed, there are occasions when portions of gingival tissue are deflected longer than necessary. For example, when retracting several teeth in preparation of making a single imprint, the gingival tissue around the first tooth is typically kept retracted for a longer period than necessary, while the dentist is retracting the gingival tissue around the other teeth using retraction threads. The longer the tissues are deflected and the longer the area is dried, the greater the potential for long-term injury. If the gingival tissues are injured, the appearance of the gingiva and the life expectancy of the tooth/implant can be negatively affected.

The current methods and materials for gingival displacement and moisture control are time-consuming and difficult for both patient and dentist. The placement of retraction threads is a delicate procedure which can cause tissue damage. The time the tissues are being displaced can be considerable, with conventional techniques, particularly if several teeth/implants are involved. Prolonged displacement of the gingival tissues can be responsible for long-term tissue injury with the consequences of deleterious cosmetic and physiologic effects.

### SUMMARY OF THE INVENTION

It is an object of the invention to provide a dental appliance that improves upon the retraction threads that are conventionally used to deflect gingival tissue.

Therefore, according to one aspect of the invention, there is provided a dental appliance for displacing gingival tissue that comprises a flexible polyurethane foam pad having a central opening extending through the pad's thickness. The central opening is configured to receive a tooth therethrough, and the foam pad has a size, shape and flexibility sufficient to deflect gingival crest surrounding the tooth.

The foam pad has a pair of major surfaces; at least one of the major surfaces can comprise a plurality of open-celled pores that are effective to retain a medicament. In particular, one of the major surfaces can be sealed and the other major surface can comprise open-celled pores in which a medicament is retained for discharging onto gingival tissue. The open-celled pores can be saturated with one or more semi-solid water soluable medicaments selected from the group of: aluminum chloride, ferric sulphate, chlorhexiden gluconate, fluoride, carbamyl peroxide, antibiotics, dentin conditioner, dentin bonding agent, and dentrifice.

The foam pad can have a density between 10 and 40 kg/m³ and an indentation force deflection (IDF) between 10 and 95.

The central opening can be a pair of cross-cut slits, a longitudinal slit, or a rounded perforation, and the foam pad can have a width between 4.0 and 15.0 mm, a length between 10.0 and 200.0 mm, and a thickness between 1.0 and 5.0 mm. The foam pad can have a profile selected from the group of circular, oval, square, rectangular, elongated, star-shaped, and bean-shaped. When the profile is star-shaped, the foam pad has a point-to-point length of between 15.0 mm and 25.0 mm, and a cut-in of between 3.0 mm and 7.0 mm.

According to another aspect of the invention, there is provided a dental appliance for displacing gingival tissue that comprises a a flexible polyurethane foam pad having a central opening extending through the layer's thickness and a gelatinized composition on the foam pad and comprising a medicament and an excipient. The excipient component of the gel preparation may be methylcellulose or polyethylene glycol, and the medicament can be selected from the group of: aluminum chloride, ferric sulphate, chlorhexiden gluconate, carbamyl peroxide, antibiotics, dentin conditioner, and dentin bonding agent.

### BRIEF DESCRIPTION OF THE DRAWINGS

FIGS. 1 (a) and (b) are buccal (cheek) and proximal views of a natural tooth and gingival tissue before preparation.

FIGS. 2(a) and (b) are buccal and proximal views of the tooth and gingival tissue of FIG. 1 after preparation and before gingival deflection.

FIGS. 3(a) and (b) are buccal and proximal views illustrating a conventional method of deflecting the gingival tissue using a fibrous thread during the recording stage (PRIOR ART).

FIG. 4 is a proximal view of a titanium dental implant and restorative component surrounded by a gingival crest.

FIGS. 5 and 6 are buccal and proximal views illustrating a method of placing a gingival deflector according to a first embodiment of the invention over a prepared tooth to deflect the surrounding gingival tissue, in anticipation of recording.

FIGS. 7(a) and (b) are buccal and proximal views of the deflected gingival tissue in FIGS. 5 and 6 after the gingival deflector has been removed from the tooth.

FIG. 8 is a plan view of a second embodiment of the gingival deflector, having a generally rectangular profile.

FIG. 9 is a plan view of the first embodiment of the gingival deflector, having a generally oval shaped profile.

FIG. 10 is a plan view of a third embodiment of the gingival deflector, having a bean-shaped profile.

FIG. 11 is a plan view of a fourth embodiment of the gingival deflector, having a star-shaped profile.

FIG. 12 is a plan view of a fifth embodiment of the gingival deflector, having an elongated rectangular profile.

### DETAILED DESCRIPTION OF EMBODIMENTS OF THE INVENTION

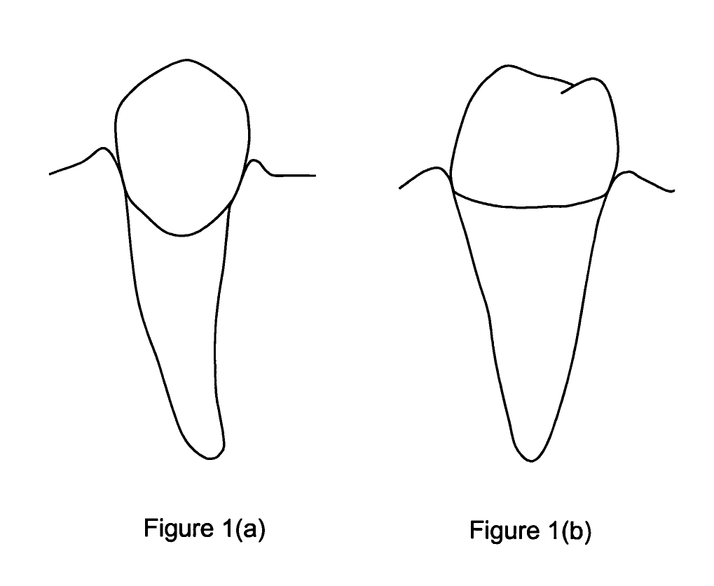

Referring to FIG. 1, the gingiva is the part of the epithelial tissue lining the mouth that covers the jaw bones in the region of the teeth. It is continuous with the sockets surrounding the roots of the teeth; the edge of the gingiva surrounding a tooth is known as the gingival crest. The portion of the tooth extending above the gingiva is known as the crown, and comprises a pulp core, dentin material surrounding and protecting the pulp, and a hard, translucent enamel layer covering the dentin.

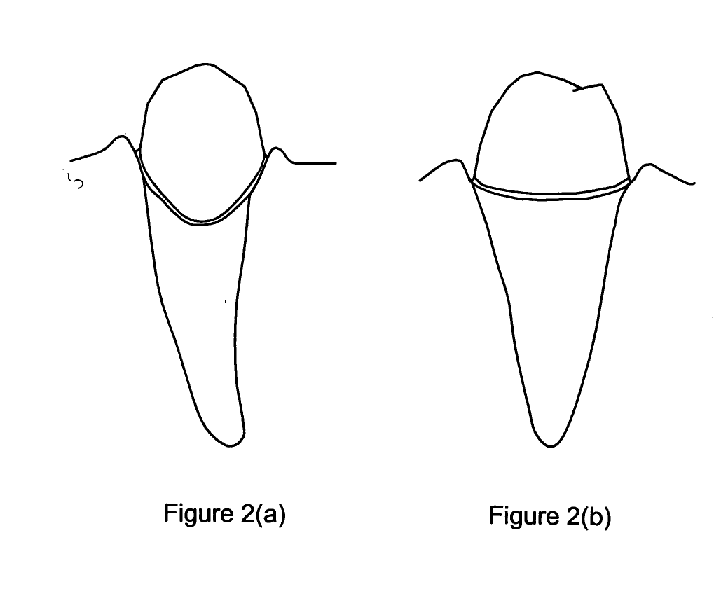

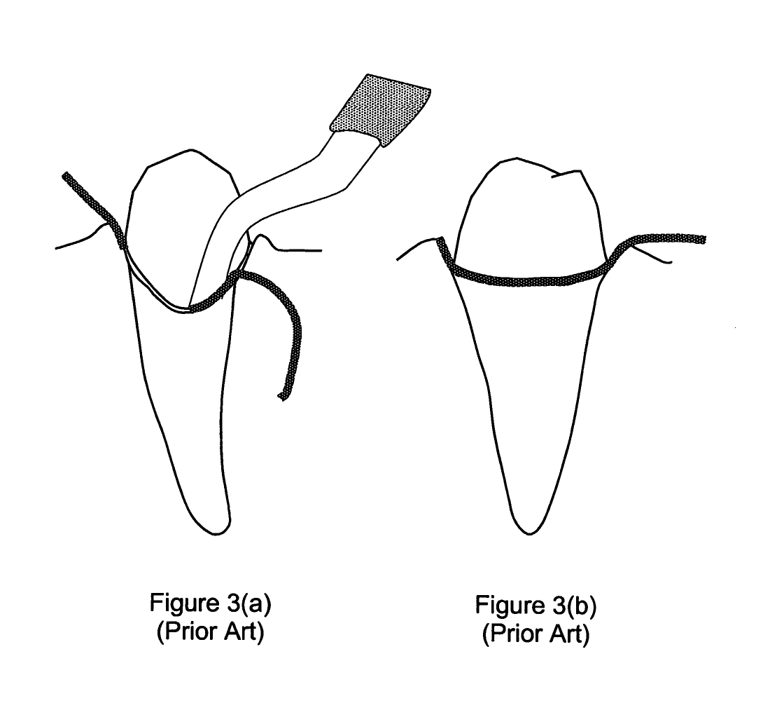

Decay of the crown can be such that the damaged portion of the crown must be removed and replaced with a restoration. Referring to FIG. 2, a dentist first removes the damaged portion of the crown with a drill during a preparation stage. Then, during a recording stage, the dentist records the shape of the prepared tooth using an impression material such as a fluid impression cream, which subsequently solidifies into a rubbery imprint. Then, dental stone is then poured into the imprint to create a replica of the prepared tooth, and a restoration is created from the replica by a dental laboratory. Then, the dentist cements the restoration onto the remaining portion of the tooth during a cementing stage. During the time the restoration is being made, the patient can be fitted with a temporary plastic crown that fits over the prepared tooth.

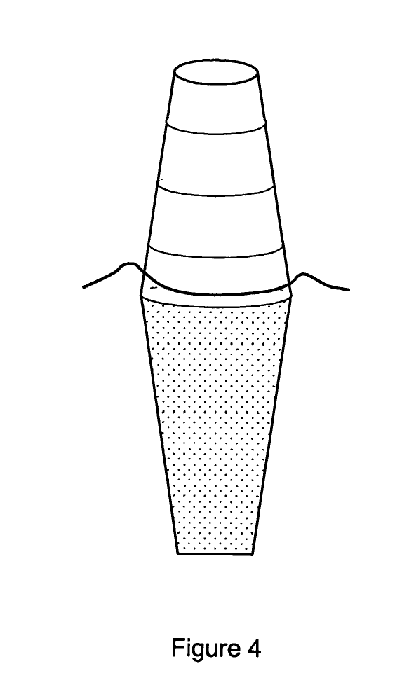

If a damaged tooth is beyond repair, it must be extracted and replaced with an artificial tooth; in such case, an implant such as a titanium post is inserted into the jaw bone, then is capped with an artificial tooth (see FIG. 4).

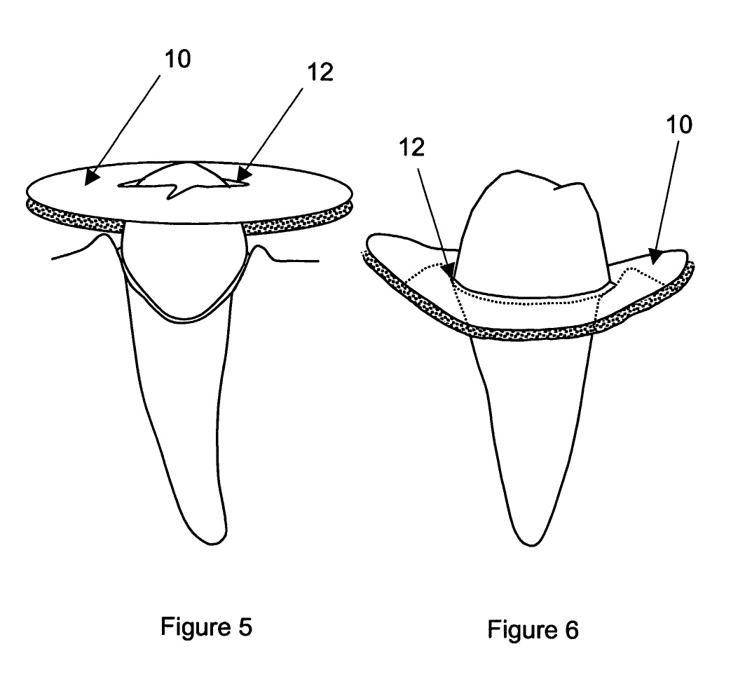

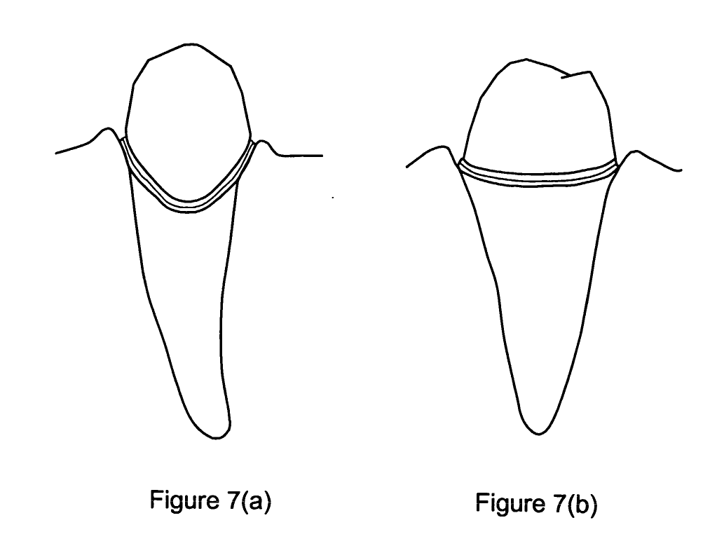

During the recording stage, and sometimes during the preparation and cementing stages, the gingival crest has to be deflected in order to visualize the portion of the tooth around or below the gingival crest. According to one embodiment of the invention and referring to FIGS. 5 and 6, a gingival deflector 10 is provided that replaces the use of conventional retraction threads. The deflector 10 is a flexible, thin absorbent pad that has a central opening 12 designed to fit over a prepared tooth.

The deflector 10 is fabricated from an open-celled flexible polyurethane foam. In particular, multiple deflectors 10 are cut from a flexible polyurethane foam sheet. To provide the deflector with the requisite flexibility and strength, the foam sheet has a density of between 10 and 40 kg/m³ (0.8 and 6.0 pcf) and an indentation force deflection (IFD) of between 10 and 95.

As is known in the art, the foam is produced from a reaction of two key chemicals, namely a polyol and an isocyanate with a blowing agent. In particular, the foam for the deflector 10 can be made by combining a polyol and toluene dioscyanate with water. These chemicals are mixed together vigorously in high intensity mixers in specific amounts with other ingredients (e.g. catalysts, surfactants). The foam reaction begins almost immediately, with the water reacting with the toluene dioscyanate to produce CO₂ gas. Bubbles are formed, and the mixture expands for several minutes until the reaction is completed. The resultant foam cells resemble an irregular honeycomb, having walls or “struts” and pores, or “windows”. Two types of foam can be produced, one wherein the struts are primarily intact, and another wherein some of the struts are ruptured to provide series of interconnected windows; the former is known as a closed cell foam, and the latter is known as an open-celled foam.

The deflector 10 is made with an open-celled foam; one major surface can be sealed, thereby leaving the other major surface with a surface of open celled pores. Optionally, both major surfaces can be left unsealed.

The deflector 10 is optionally saturated with semi-solid, water soluable medicaments, such as aluminum chloride, ferric sulphate, chlorhexiden gluconate, fluoride, carbamyl peroxide, antibiotics, dentin conditioner, dentin bonding agent, and dentrifice. Some of these medicaments, such as aluminum chloride, ferric sulphate, chlorhexiden gluconate and carbamyl peroxide, can be provided in semi-solid form by combining medicament in powder or liquid form with a suitable excipient to form a gelatinized composition (“medicament gel”).

The medicament gel is particularly suitable for use with the foam material of the deflector, as the gel tends to express more slowly from the deflector 10 than a purely liquid medicament. Such slower expression is desirable to prevent medicament from being prematurely expressed, and to keep the medicament at the target area for a longer period of time. Premature expression may result in contact between open cells of the foam and the patient's gum, in which case care must be taken in handling the deflector 10 to avoid the open cells pulling the tissue and causing bleeding. Accordingly, the medicament gel should have a viscosity that enables at least some of the gel to remain in the open cells of the deflector 10 during the entire treatment.

Suitable excipients for such a gel include synthetic polymers such as polyethylene glycol and cellulose derivatives like methylcellulose. A suitable polyethylene glycol excipient can be formed by mixing polyethylene glycol powder and purified water in a range of 100-500 wt. % and preferably 300 wt. % of powder to water. A suitable methylcellulose excipient can be formed by mixing methylcellulose powder and purified water in a range of 1-5 wt. % and preferably 3 wt. % of powder to water. Either of these two excipients can be combined with the following medicaments in powder form:
20-40 wt. % and preferably 30 wt. % aluminum chloride (of total weight with excipient);
15-30 wt. % and preferably 20 wt. % ferric sulphate (of total weight with excipient);
0.1 to 3 wt. % and preferably 1% chlorhexidene gluconate (of total weight with excipient); and
15-40 wt. % and preferably 25% carbamyl peroxide (of total weight with excipient).

The deflector 10 can be packaged with its open-celled surface already impregnated with the medicament gel. The packaging should be air-tight to prevent the medicament gel from drying out. Alternatively, the deflector 10 and medicament gel can be packaged separately, and combined during treatment. In this latter case, the gel can be poured into a container and the deflector can be soaked in the container.

To absorb the medicaments, the deflector 10 is made with an open-celled foam. When the deflector 10 contacts the gingival tissue, the foam distorts and releases the stored medicament onto the gingival tissue, whether the medicament be in gelatinous or another semi-solid form. Because of the open-celled design of the foam, the deflector 10 also is effective in soaking up fluid such as gingival crevicular fluid and blood. The deflector 10 can be sealed at one major surface so that the medicaments are released entirely from the other major surface.

The deflector 10 can have a variety of profiles and dimensions; the dentist can choose the shape of the deflector depending on the tooth size, location, and adjacent tooth shape. In this first embodiment, and referring to FIGS. 5, 6, and 9, the deflector has a generally oval profile (as seen in plan view). The oval profile deflector 10 can have a length between 10.0 mm and 200.0 mm and preferably one of 10 mm, 15 mm, 20 mm, 30 mm and 40 mm, a width between 7.0 mm and 15.0 mm, and a thickness between 1.0 mm and 5 mm. The opening 12 comprises a pair of cross cut slits of 5.0 mm by 5.0 mm.

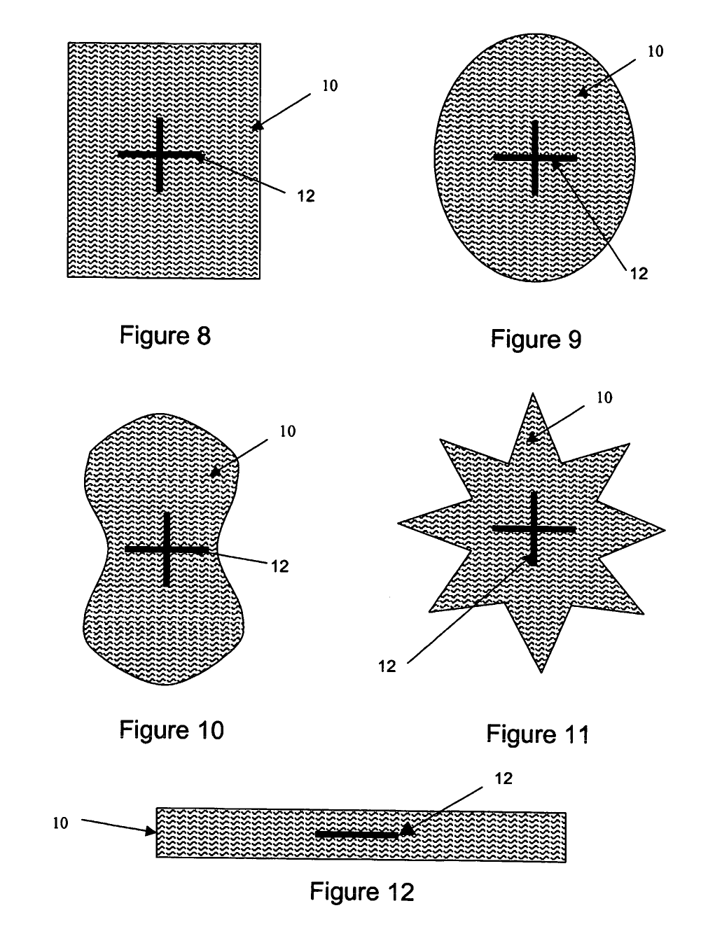

FIGS. 8, 10, 11 and 12 show alternate deflector profiles: a rectangular profile deflector as shown in FIG. 9 is useful for molar teeth, a bean shaped profile as shown in FIG. 10 is useful for anterior teeth, and a star-shaped profile deflector is particularly useful for teeth surrounded by deep gingival sulci. The deflector 10 can also have a circular or square profile. The central opening 12 in any of these embodiments can be a pair of cross-cut slits, a single linear slit, or another shape that allows the deflector to slide snugly over the tooth and still retain its shape enough to deflect the surrounding gingival tissue. For example, the central opening 12 can be a rounded perforation (not shown).

The rectangular and bean shaped deflectors 10 each has a length between 10.0 mm and 200.0 mm, a width of between 7.0 mm and 15 mm, a thickness of between 1.0 mm and 5.0 mm.

Referring to FIG. 12, an elongated rectangular deflector 10 is provided having a length between 10.0 mm and 200.0 mm, a width of between 4.0 mm and 15.0 mm, and a thickness of between 1.0 mm and 5.0 mm and a longitudinal linear slit.

The star-shaped profile deflector 10 has a point-to-point length of between 15.0 mm and 25.0 mm, and a cut-in of between 3.0 mm and 7.0 mm.

As mentioned above, the deflector 10 can be cut from a foam sheet into any of these profiles. Alternatively, each deflector 10 can be individually packaged to maintain sterility.

Optionally, the deflector 10 can have an elongated profile and multiple openings 12 to enable the deflector 10 to be applied to multiple teeth. The multiple openings 12 are located on the deflector 10 in positions that correspond to the position of the teeth to which the deflector 10 is to be applied.

In operation, the deflector 10 is used to deflect gingival tissue during the recording stage. The damaged tooth is prepared according to the techniques as is known in the art. During recording, instead of tamping a thread into the gingival sulcus as is conventionally done in the art, the deflector 10 is inserted over the prepared tooth, and pushed onto the gingival crest using the temporary crown. The temporary crown can be any one of the commercially available temporary crowns having a prefabricated shell with a soft molding material inside. The temporary crown is a particularly effective deflector application device, as the temporary crown causes the deflector 10 to simultaneously displace the gingival crest surrounding the prepared tooth, which has the benefits of evenly distributing force around the gingival crest as well as saving time over multiple tamping of retraction thread segments. The deflector 10 is held in place for about three minutes so that when removed the gingival tissue remains deflected long enough for the recording to be made. During this time, the medicaments stored in the deflector 10 are released onto the gingival tissue.

It has been found that the time in which it takes to install the deflector 10 is substantially shorter than the time taken to install a retraction thread. In certain cases, the deflector 10 can be installed in around ⅕^{th} the time it typically takes to install a deflector cord in the same circumstances.

The deflector can also be used to deflect gingival tissue during the cementing stage. At the time of cementing the permanent restoration, the deflector 10 can be placed as described above onto the prepared tooth and compressed into place using the permanent restoration. The deflector 10 may be saturated with disinfection and dentin conditioning agents that are released during the cementation stage.

While the present invention has been described herein by the preferred embodiments, it will be understood to those skilled in the art that various changes may be made and added to the invention. The changes and alternatives are considered within the spirit and scope of the present invention.

What is claimed is:

1. A dental appliance for displacing gingival tissue, comprising
a flexible polyurethane foam pad having a central opening extending through the pad's thickness, the central opening being configured to receive a tooth therethrough, and the foam pad having a size, shape and flexibility sufficient to deflect gingival crest surrounding the tooth.

2. The appliance of claim 1 wherein the foam pad comprises a pair of major surfaces, wherein at least one of the major surfaces comprises a plurality of open-celled pores effective to retain a medicament.

3. The appliance of claim 2 wherein one of the major surfaces is sealed and the other major surface comprises open-celled pores and the appliance further comprises a medicament retained in the open-celled pores for discharge onto gingival tissue.

4. The appliance of claim 3 wherein the open-celled pores are saturated with one or more semi-solid water soluable medicaments selected from the group of: aluminum chloride, ferric sulphate, chlorhexiden gluconate, fluoride, carbamyl peroxide, antibiotics, dentin conditioner, dentin bonding agent, and dentrifice.

5. The appliance of claim 1 wherein the foam pad has a density between 10 an 40 kg/m³.

6. The appliance of claim 1 wherein the foam pad has an indentation force deflection (IDF) between 10 to 95.

7. The appliance of claim 1 wherein the central opening is a pair of cross-cut slits.

8. The appliance of claim 1 wherein the central opening is a linear slit.

9. The appliance of claim 1 wherein the central opening is a rounded perforation.

10. The appliance of claim 1 wherein the foam pad has a width between 7.0 and 15.0 mm, a length between 10.0 and 200.0 mm, and a thickness between 1.0 and 5.0 mm.

11. The appliance of claim 10 wherein the foam pad has a profile selected from the group of circular, oval, square, rectangular, star-shaped, and bean-shaped.

12. The appliance of claim 11 wherein the foam pad has a star-shaped profile with a point-to-point length of between 15.0 mm and 25.0 mm, and a cut-in of between 3.0 mm and 7.0 mm.

13. The appliance of claim 1 wherein the foam pad has an elongated profile and multiple central openings arranged through the foam pad to enable the appliance to be applied to multiple teeth.

14. A dental appliance for use in dental applications, comprising
(a) a flexible polyurethane foam pad having a central opening extending through the pad's thickness, the central opening being configured to receive a tooth therethrough, and the foam pad having a size, shape and flexibility sufficient to deflect gingival crest surrounding the tooth; and
(b) a medicament gel impregnated in the foam pad and comprising a medicament and an excipient.

15. The appliance of claim 14 wherein the excipient is selected from the group of methylcellulose and polyethylene glycol.

16. The appliance of claim 15 wherein the medicament is selected from the group of aluminum chloride, ferric sulphate, chlorhexidene gluconate, and carbamyl peroxide.

17. The appliance of claim 16 wherein the methylcellulose exicipient has a 1-5 wt. % metyhylcellulose to water.

18. The appliance of claim 16 wherein the polyethylene glycol exicipient has a 100-500 wt. % metyhylcellulose to water.

19. The appliance of claim 16 wherein the gel has a medicament concentration of 20-40 wt. % aluminum chloride.

20. The appliance of claim 16 wherein the gel has a medicament concentration of 15-30 wt. % ferric sulphate.

21. The appliance of claim 16 wherein the gel has a medicament concentration of 0.1-3.0 wt. % chlorhexidene gluconoate.

22. The appliance of claim 16 wherein the gel has a medicament concentration of 15-40 wt. % carbamyl peroxide.
